(19) United States
(12) Patent Application Publication
(10) Pub. No.: US 2010/0091994 A1
(43) Pub. Date: Apr. 15, 2010

(54) Encryption Validation Systems and Related Methods and Computer Program Products for Verifying the Validity of an Encryption Keystore

(75) Inventor: Andrew Schiefelbein, St. Louis, MO (US)

Correspondence Address: AT&T Legal Department - MB;Attn: Patent Docketing, Room 2A-207, One AT&T Way, Bedminster, NJ, 07921, US

(73) Assignee: AT&T Intellectual Property I, L.P.

(21) Appl. No.: 12/250,170

(22) Filed: Oct. 13, 2008

(51) Int. Cl. H04L 9/00

(52) U.S. Cl. 380/277

(57) ABSTRACT

Methods for verifying the operability of an encryption keystore are provided. Pursuant to these methods, the keystore may be periodically checked to verify that it has each required CA authority. If one or more of the required CA authorities are missing from the keystore, then an alert is automatically issued. The methods may also include periodically checking the keystore to verify that the keystore has each required digital certificate and that each digital certificate operates properly. The methods can further include periodically checking the keystore to determine if any of the required CA authorities and/or digital certificates have expired and/or are set to expire within a predetermined time period. Related encryption validation systems and computer program products are also provided.

### BACKGROUND

This disclosure relates to encryption and, more particularly, to methods and computer program products for verifying proper operation of encryption systems and encryption validation systems that implement such methods and/or computer program products.

Communications that are carried out over the Internet or other public and private networks are often vulnerable to tampering, message forgery, eavesdropping and the like. Confidential information such as credit card numbers, social security numbers, bank account numbers and passwords, other financial information, personal information, competitively sensitive business information and the like is routinely transmitted via the Internet and/or some other public or private network where it is vulnerable to eavesdropping or may otherwise be compromised. In order to reduce or prevent the theft of such confidential information, a number of encryption protocols have been developed that allow two computing devices to establish a secure, encrypted link over the Internet and/or other networks. Two common protocols are the Secure Socket Layer (“SSL”) protocol and various variants thereof such as the Transport Layer Security (“TLS”) protocol and the Secure HTTP (“S-HTTP”) protocol (hereinafter the SSL and TLS protocols and variants thereof will generically be referred to as “the SSL protocol” or “SSL” for ease of description). These protocols can be used (1) to authenticate one or both of the parties to the communication (i.e., ensuring that the computing device on the other end of the connection is in fact who it claims to be) and (2) provide a secure, private communications link between the two computing devices that is not readily susceptible to eavesdropping, message forgery, tampering and the like.

The SSL protocol uses a two key cryptographic system to encrypt data. The first key is a public key that may be provided to anyone, and the second key is a secret, private key that is known only to the recipient of the message. Many Internet browsers (e.g., Netscape®, Internet Explorer®, etc.) support SSL, as do many, if not most, Web sites run by commercial and government entities that collect confidential information over the Internet. The SSL protocol creates a secure communications connection through a network between two computing devices, over which data can be sent once the secure connection is established. The S-HTTP protocol operates differently in that it is designed to transmit individual messages securely.

SSL is commonly used to set up a secure connection between a web browser on a client computer and a server associated with a website. Typically, with such communications, the client authenticates the server to make sure that the server is who or what it purports to be, but the server does not authenticate the client. This is referred to as “single-sided authentication.” In other instances, however, “mutual authentication” may be performed where both the server and the client authenticate that the other is who or what it purports to be. Mutual authentication is also routinely used when two servers communicate with each other.

To set up a secure SSL communications link, the server will typically send a digital certificate that is called an SSL certificate to the web browser on the client computer. The SSL certificate is a file that includes an embedded public key. The SSL certificate is “digitally signed” by a trusted third party that is known as a “Certificate Authority.” A Certificate Authority is a third party entity such as Verisign that issues digital certificates that confirm that the holder thereof is who they purport to be. The web browser on the client computer will typically have files provided by the Certificate Authorities embedded therein that are used to decrypt and read SLL certificates. These files are commonly referred to as “CA authorities.” Upon receiving an SSL certificate from a server, the web browser selects the corresponding CA authority and uses it to decrypt the received SSL certificate to verify that it is valid and to extract the public key that will be used to set up the secure connection. Unfortunately, however, a number of error conditions can prevent establishment of an SSL link. If these error conditions occur, either the secure connection cannot be set up or, the connection may be established, but the client may have no assurance that the connection is in fact secure, which may cause the client to decline to establish the connection.

### SUMMARY

Methods for verifying the operability of an encryption keystore are provided. Pursuant to these methods, the keystore may be periodically checked to verify that it has each required CA authority. If one or more of the required CA authorities are missing from the keystore, then an alert is automatically issued. In some embodiments, these methods can further include periodically checking the keystore to determine if any of the required CA authorities have expired and/or are set to expire within a predetermined time period. If so, an appropriate alert may be issued. The methods may also include periodically checking the keystore to verify that the keystore has each required digital certificate. If one or more of the required digital certificates are missing from the keystore, then an alert is automatically issued.

In other embodiments, the methods may further include periodically testing a first of the required digital certificates to determine if the first of the required digital certificates operates properly. If one or more of the required digital certificates is found to be inoperable, then an alert is issued. These methods can further include periodically checking the keystore to determine if any of the required digital certificates have expired and/or are set to expire within a predetermined time period. If so, an appropriate alert may be issued.

Encryption validation systems are also provided that may be used to validate an encryption keystore that contains digital certificates and CA authorities. These encryption validation systems may include a verifier that is configured to periodically check the keystore to determine if the keystore includes each of a specified set of CA authorities and each of a specified set of digital certificates. In some embodiments, the verifier may also be configured to periodically check the keystore to determine if any of the digital certificates and/or if any of the CA authorities are expired and/or set to expire within a predetermined time. In still further embodiments, the verifier may also or alternatively be configured to periodically check the digital certificates to determine if each of the digital certificates operates properly. The verifier may further be configured to periodically check if a password for the keystore has expired. The verifier may automatically issue an alert if any of the specified sets of CA authorities or digital certificates are missing, expired, about to expire or inoperable.

Embodiments have been described herein primarily with respect to encryption validation systems and methods for verifying the operability of an encryption keystore. However, analogous computer systems and computer-based methods for verifying the operability of an encryption keystore may also be provided according to other embodiments.

Other systems, methods and/or computer program products according to other embodiments will be or become apparent to one with skill in the art upon review of the following drawings and detailed description. It is intended that all such additional systems, methods, and/or computer program products be included within this description and be protected by the accompanying claims.

### BRIEF DESCRIPTION OF THE DRAWINGS

FIG. 1 is a schematic block diagram illustrating an environment in which a client and a server engage in secure communications over a network.

FIG. 2 is a simplified block diagram of an exemplary SSL certificate.

FIG. 3 is a block diagram of an embodiment of an encryption validation system.

FIG. 4 is a flowchart of a method of verifying that a server has a valid and operable keystore.

### DETAILED DESCRIPTION

Encryption validation systems and related methods and computer program products will now be described more fully hereinafter with reference to the accompanying drawings, in which illustrative embodiments are shown. However, it will be appreciated that these encryption validation systems and related methods and computer program products may be embodied in many different forms, and thus the present application should not be construed as limited to the embodiments set forth herein. Rather, these embodiments are provided so that this disclosure will be thorough and complete.

It will be understood that when an element is referred to as being “coupled”, “connected” or “responsive” to another element, it can be directly coupled, connected or responsive to the other element or intervening elements may also be present. In contrast, when an element is referred to as being “directly coupled”, “directly connected” or “directly responsive” to another element, there are no intervening elements present. Like numbers refer to like elements throughout. As used herein the term “and/or” includes any and all combinations of one or more of the associated listed items.

It will also be understood that, although the terms first, second, etc. may be used herein to describe various elements, these elements should not be limited by these terms. These terms are only used to distinguish one element from another element.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art in light of the present disclosure, and will not be interpreted in an idealized or overly formal sense unless expressly so defined herein.

The present disclosure includes block diagrams and flowcharts of methods, systems and computer program products according to various embodiments. It will be understood that a block of the block diagrams or flowcharts, and combinations of blocks in the block diagrams or flowcharts, may be implemented at least in part by computer program instructions. These computer program instructions may be provided to one or more enterprise, application, personal, pervasive and/or embedded computer systems, such that the instructions, which execute via the computer system(s) create means, modules, devices or methods for implementing the functions/acts specified in the block diagram block or blocks. The computer program discussed in such embodiments comprises a computer usable storage medium having computer-readable program code embodied therein. Combinations of general purpose computer systems and/or special purpose hardware also may be used in other embodiments.

These computer program instructions may also be stored in memory of the computer system(s) that can direct the computer system(s) to function in a particular manner, such that the instructions stored in the memory produce an article of manufacture including computer-readable program code which implements the functions/acts specified in block or blocks. The computer program instructions may also be loaded into the computer system(s) to cause a series of operational steps to be performed by the computer system(s) to produce a computer implemented process such that the instructions which execute on the processor provide steps for implementing the functions/acts specified in the block or blocks. Accordingly, a given block or blocks of the block diagrams and/or flowcharts provides support for methods, computer program products and/or systems.

It should also be noted that in some alternate implementations, the functions/acts noted in the flowcharts may occur out of the order noted in the flowcharts. For example, two blocks shown in succession may in fact be executed substantially concurrently or the blocks may sometimes be executed in the reverse order, depending upon the functionality/acts involved. Likewise, the functionality of one or more blocks of either the flowcharts or the block diagrams may be separated and/or combined with that of other blocks.

Methods, systems and computer program products are disclosed herein that may be used to ensure that a production server or other computer processing device has all of the digital certificates and “CA authorities” that it needs to establish secure communications with client computers and/or other computer processing devices (e.g., other servers), and that the digital certificates and CA authorities associated with the server are valid, unexpired and fully operable. As such, these methods, systems and computer program products may be used to ensure that “keystores” associated with the production server are free from error conditions so that client computers or other devices attempting to establish a secure communications connection with the production server will not receive error messages and refuse to establish a connection with the production server.

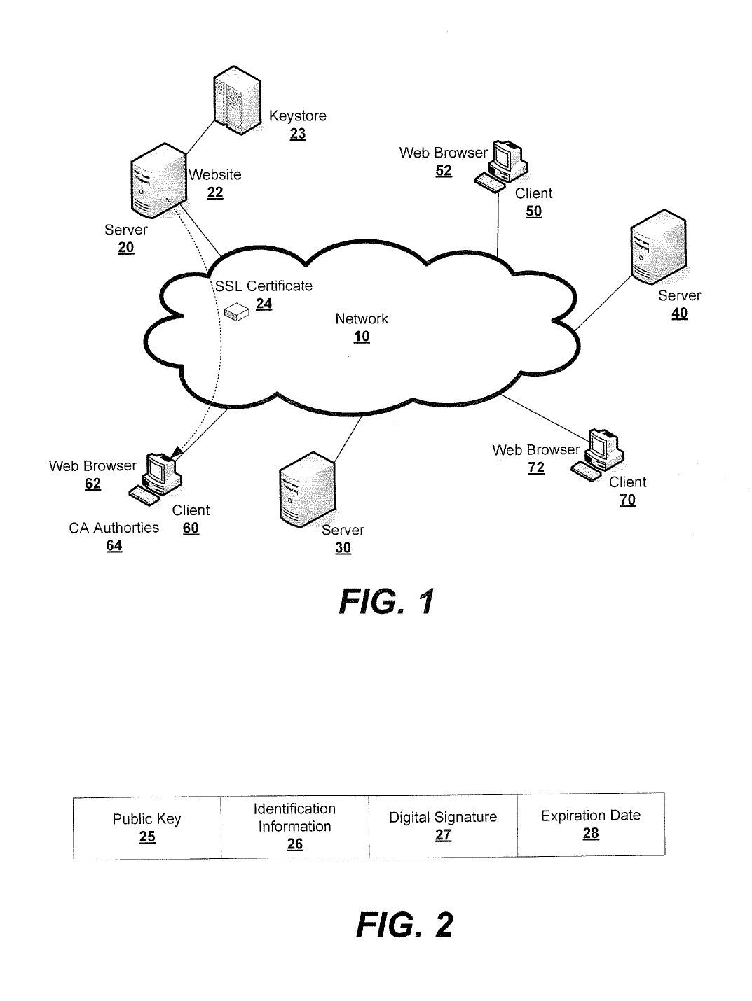

FIG. 1 is schematic block diagram of a networked computing environment in which the methods, systems and computer program products described herein may be used. As shown in FIG. 1, a server 20 is connected to a network 10 such as the Internet. A plurality of client computers 50, 60, 70 are likewise connected to network 10, as are other servers 30, 40. In FIG. 1, server 20 may be owned or operated, for example, by a commercial entity such as a financial institution, an online retailer, a service provider (e.g., telephone company, cable television provider, etc.) or the like, or by a governmental entity. A website 22 may be hosted on server 20. The server 20 has an associated “keystore” 23, which is discussed in more detail below. Client computers 50, 60, 70 may use, for example, web browsers 52, 62, 72 that are resident on the respective client computers 50, 60, 70 to access website 22. Website 22 may request confidential or sensitive information from, for example, the user of the client computer 60 such as, for example, credit card numbers, social security numbers, bank account information, personal information (name, age, address, medical history, etc.) or the like. In order to prevent interception and/or eavesdropping through which this confidential information could be provided to unauthorized parties or otherwise compromised, a secure communication link is established between server 20 and client computer 60. Establishment of this secure communication link involves (1) authenticating that one or both of server 20 and client computer 60 are in fact who they purport to be and (2) establishing a communication link between server 20 and client computer 60 that is encrypted in at least one direction so that, for example, eavesdroppers cannot read the confidential information that is passed between server 20 and client computer 60.

Establishment of a secure SSL communication link between web browser 62 and server 20 will now be described with reference to FIG. 1. Operations may begin with web browser 62 attempting to access a secured domain within server 20 and/or with server 20 reaching a point where it needs to request confidential information from client computer 60. When this occurs, the server 20 initiates an SSL handshake procedure that is used to authenticate the server (single-sided authentication) and perhaps the client as well (in instances of mutual authentication). During the SSL handshake, the web browser 62 requires authentication information from the server 20, including a digital certificate 24 that is referred to as an SSL certificate 24. The SSL certificate 24 is typically implemented as an encrypted file that resides on the server 20 or which is otherwise accessible by the server 20. The server 20 will have previously received this SSL certificate 24 from a Certificate Authority. As noted above, the web browser 62 will typically have a plurality of “CA authorities” 64. A CA authority is a file (or information in another form such as information stored in a database, register, etc.) that includes information as to how to decrypt and read a digital certificate 24 so that the public key and other information may be extracted therefrom. Each CA authority 64 will correspond to one or more different types of SSL certificate 24. Multiple CA authorities are typically necessary to fully decrypt and read an SSL certificate 24. When an SSL certificate 24 is forwarded from the server 20 to the web browser 62, the web browser 62 selects the applicable CA authority (or CA authorities) 64 and uses it/them to decrypt the SSL certificate 24. Typically, new CA authorities 64 are distributed to web browsers as part of routine automatic software updates.

FIG. 2 is a simplified block diagram of an SSL certificate 24. As shown in FIG. 2, the SSL certificate 24 includes a public cryptographic key (“public key”) 25, identification information (e.g., an organization name, a server name, address or location information or the like) 26 as well as a digital signature 27 of a Certificate Authority (i.e., something that indicates that the SSL certificate 24 was issued by a particular Certificate Authority) and an expiration date field 28 which contains an expiration date for the certificate. Once the public key is extracted from the SSL certificate 24, it may be used by the web browser 62 to encrypt messages that are sent to the server 20. The server 20 has a private key 29 that is associated with the public key and that is generally known only to the server 20. This private key 29 allows the server 20 to decrypt communications that it receives which are encrypted using the public key 25. As noted above, the Certificate Authority is a trusted entity that verifies that entities requesting am SSL certificate are who they say they are. The signature 27 of the Certificate Authority included in the SSL certificate 24 provides an assurance to the web browser 62 that the SSL certificate 24 received by the web browser 62 was in fact issued by the individual or entity identified in the identification information 26 included in the SSL certificate 24, and that this identified entity is a verified, legitimate business, government or other entity. Thus, by obtaining the SSL certificate 24 from the server 20, the web browser 62 can use a stored CA authority 64 to authenticate that the server 20 is who or what it purports to be, and a mechanism is provided for the web browser 62 and server 20 to establish a secure, encrypted communications channel.

SSL certificates 24 are typically stored by the server 20 in the keystore 23. The server 20 will also store CA authorities 64 in keystore 23, as the server requires such CA authorities 64 in instances where mutual authentication is performed. Herein, the term “keystore” is used to refer to any storage mechanism, memory location, register, database, file or the like that is used to store an encryption certificate such as an SSL certificate 24 and/or CA authorities 64. The keystore 23 may comprise a single location, memory block, file or the like, or may be a distributed keystore 23 that is stored in multiple locations, files, etc.

Unfortunately, an SSL certificate 24 may not work properly and/or may fail the authentication procedures for a number of reasons. For example, typically a Certificate Authority will include an expiration date (e.g., one year after issuance) with each SSL certificate 24 that it issues. As a result, someone associated with the entity that owns/operates the server 20 must be responsible for renewing the SSL certificates 24 each year. If the responsible person leaves the entity or fails to complete this task so that one or more SSL certificates expire, clients that receive an expired SSL certificate 24 will typically receive an error message that indicates that the web browser 62 on the client computer 60 was unable to authenticate the server 20. The entity which owns and/or operates server 20 will not necessarily know, however, that it is sending out expired SSL certificates 24. As a result, some amount of time may pass before the entity realizes that a problem exists, and during that time period, many if not most clients will decline to establish an SSL link with the server 20 due to the lack of proper authentication. This, of course, can result in a significant amount of lost business, customer dissatisfaction and various other problems.

Another problem that can arise is that a replacement SSL certificate 24 that is invalid for some reason may be placed in the keystore 23 to replace an expiring SSL certificate 24. Such an invalid certificate 24 can go through the certificate creation process without any error conditions being detected, but the certificate 24 then simply fails to work properly when placed into use. A replacement SSL certificate 24 might be invalid, for example, because it was malformed, implemented wrong, transferred in the wrong file transfer mode (creating incorrect characters), etc. Also, it is not uncommon for entities to store replacement SSL certificates 24 in the wrong location when replacing an expiring SSL certificate 24, or forget to restart the server 20 or other computing or memory device containing the keystore 23 after replacing one or more SSL certificates 24. Once again, such mistakes will typically result in error messages being displayed on client computers that attempt to establish secure SSL communications with the server 20.

Another problem that can arise is that the keystore 23 associated with server 20 may not have the CA authorities 64 that are required to decrypt and validate SSL certificates 24 that are received by the server 20. While these CA authorities 64 are only required for setting up secure communications links that involve mutual authentication, typically some amount of the communications from a commercial or government-operated server will require such mutual authentication. If one or more CA authorities are missing, located in the wrong place, malformed or expired, the server 20 typically will not be able to decrypt and validate the SSL certificate 24 that it receives from another server or from a client which it needs to authenticate.

Finally, in many instances, CMS coding may be employed to code the keystore 23 associated with a server. However, CMS coding includes a password expiration which can be set. If such a password expiration is set, and the password is not changed before the expiration date is reached, then when the system on which the keystore 23 resides is rebooted after being taken down for maintenance or other reasons, the server will not be able to access the keystore 23.

Thus, as set forth above, a variety of errors may occur that prevent successful SSL certificate authentication. When this occurs, the web browser 62 will typically issue an error message which, in many or most instances, will cause the user of web browser 62 to abort establishment of the secure communications link.

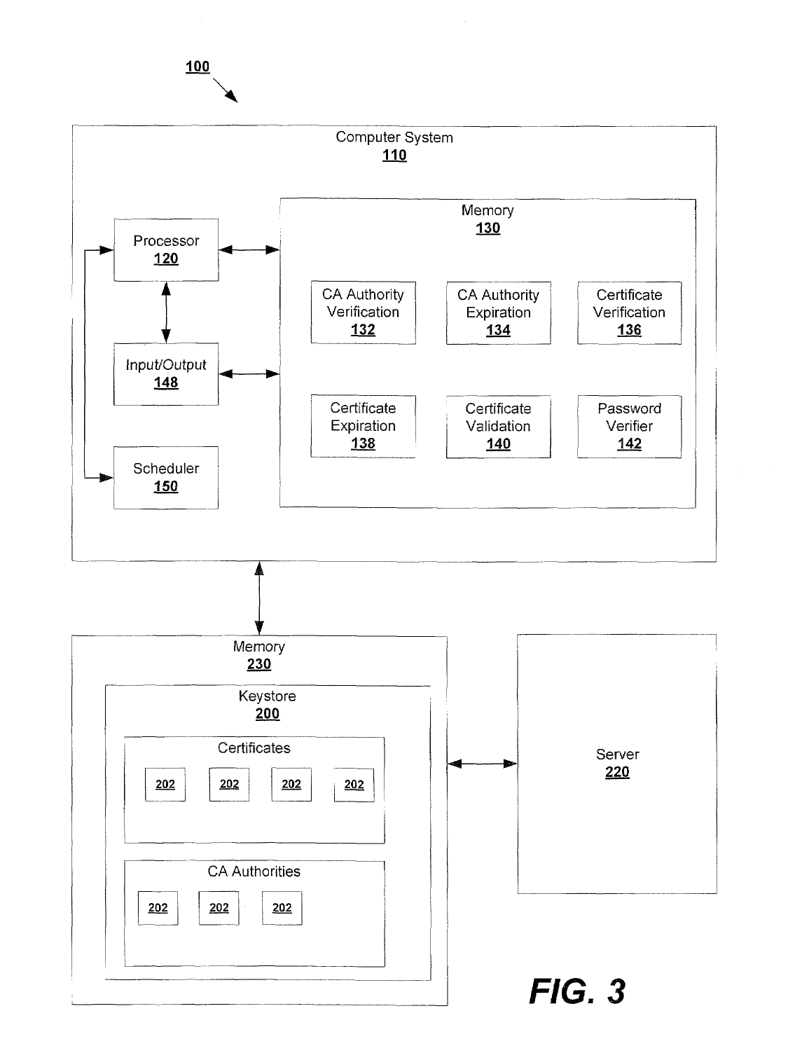

As noted above, methods, systems and computer program products are disclosed herein that may be used to ensure that server 20 has all of the SSL certificates 24 and CA authorities 64 that it needs to establish secure communications with client computer 60, and that the SSL certificates 24 and CA authorities 64 that are stored in the keystore 23 that is associated with server 20 are valid, unexpired and fully operable. FIG. 3 is a block diagram of such an encryption validation system 100. Herein, the term “encryption validation system” is used to refer to a system (which may, for example, be implemented as software running on a computer processing device) that checks one or more items stored in an encryption keystore 23 to verify that the proper items are in the keystore 23, that the items are working properly, that the items are not expired or about to expire, and/or that an expired password is not preventing access to the keystore 23.

As shown in FIG. 3, these encryption validation systems/computer program products comprise a computer system 110 that includes a processor 120 and a memory 130 that communicates with the processor 120, The processor 120 may be embodied, for example, as one or more enterprise, application, personal, pervasive and/or embedded computer systems and/or special purpose hardware that may be centralized and/or distributed and connected by a wired network and/or a wireless network. The memory 130 may represent an overall hierarchy of memory devices containing software and/or data including, but not limited to, the following types of memory devices: cache, ROM, PROM, EPROM, EEPROM, flash memory, SRAM, DRAM, removable and/or fixed media, as well as virtual storage. The memory 130 may also be centralized and/or distributed and connected by a wired network and/or a wireless network. The memory 130 may be at least partially embedded in processor 120 or may be separate therefrom.

As is also shown in FIG. 3, a CA authority verification module 132, a CA authority expiration module 134, a digital certificate verification module 136, a digital certificate expiration module 138, a digital certificate validation module 140 and a CMS password verifier module 142 may be stored in the memory 130. Other software, such as, for example, an operating system, may also be included. It will be further appreciated that the functionality of the modules 132, 134, 136, 138, 140, 142 may be embodied, at least in part, using discrete hardware components, one or more Application Specific Integrated Circuits (ASIC) and/or a special purpose digital processor. One or more user input/output devices 148 is configured to interact with the processor 120, and may be connected to the computer system 110 directly or via a wired network and/or a wireless network. It will be understood by those having skill in the art that the computer system 110 may include many other components, such as data buses, controllers, operating systems, mass storage systems, etc., that are not illustrated in FIG. 3 for ease of explanation. Modules 132, 134, 136, 138, 140, 142, and each possible subset thereof, may each comprise a “verifier” that is used to verify that the proper items are in a keystore, that the items are working properly, that the items are not expired or about to expire, and/or that an expired password is not preventing access to the keystore.

As noted above, and as shown in FIG. 3, the encryption validation system 100 is used to check on and/or verify or validate items that are stored in a keystore 200. The keystore 200 is associated with a server 220. Typically, the keystore 200 will be stored in a memory device 230 that is associated with, and/or part of the server 220, although it will be appreciated that the keystore 200 can be located elsewhere, can be distributed and/or can be stored in something other than memory (i.e., in registers). In some embodiments, the keystore 200 and the memory 130 of the encryption validation system 100 may be part of the same memory. The keystore 200 may include a plurality of digital certificates 202, 204, 206, 208. Multiple digital certificates 202, 204, 206, 208 are provided because (1) there are multiple Certificate Authorities, each of which issue their own digital certificates, (2) Certificate Authorities typically issue more than one type of digital certificate and (3) a particular digital certificate may have to be “chained” using multiple CA authorities to complete the authentication/decryption process. A commercial, governmental or other entity that runs a server that engages in secure communications will typically specify in advance the different digital certificates that are to be stored in a given keystore based on the types of activities the server or other computer processing device associated with the keystore is engaged in. The keystore 200 likewise includes a plurality of CA authorities 210, 212, 214. Once again, the CA authorities 210, 212, 214 stored in keystore 200 will typically be specified in advance by the entity that operates server 220 (or on whose behalf server 220 is operated).

In some embodiments, the encryption validation system 100 may be implemented as software that is stored in the memory 130, although the encryption validation system 100 may be stored in other locations. As noted above, this software may comprise one or more of the following functional blocks: a CA authority verification module 132, a CA authority expiration module 134, a digital certificate verification module 136, a digital certificate expiration module 138, a digital certificate validation module 140 and a CMS password verifier module 142. The modules 132, 134, 136, 138, 140, 142 may be used to ensure that the keystore 200 includes various necessary items, verify that those items operate properly and are not expired (or about to expire). These modules are referred to as “functional blocks” to make clear that the encryption validation system 100 may include software and/or hardware that carries out the specific functions of at least some of these blocks, regardless of whether or not the software/hardware comprises, for example, a composite unit or a plurality of discrete units that correspond to each module.

The CA authority verification module 132 is used to verify that the keystore 200 includes each required CA authority 210, 212, 214. As noted above, CA authorities expire and must be periodically replaced, typically through a manual (i.e., not automatic) operation. When this occurs, the individual that is responsible for replacing an expired CA authority may forget to replace the CA authority before it expires, may replace the CA authority with the wrong CA authority, may store the replacement CA authority in the wrong location or make any of a variety of other errors that result in the keystore 200 not having an unexpired version of each required CA authority 210, 212, 214. If this occurs, the server 220 will generate an error message when it attempts to establish a mutual SSL authentication with another computing device that sends a digital certificate to server 220 that requires reference to the missing unexpired CA authority. To prevent this error condition from occurring, CA authority verification module 132 is used to periodically (e.g., once a week) compare the CA authorities stored in keystore 200 to a predetermined list of required CA authorities that are listed in CA authority verification module 132. If any of the required CA authorities are missing, CA authority verification module 132 generates an alert that notifies an operator that a required CA authority is missing. This alert may comprise, for example, an e-mail message that is automatically sent to the operator.

The CA authority expiration module 134 periodically checks to make sure that none of the CA authorities have expired. The CA authority expiration module 134 may accomplish this, for example, by scanning an expiration date field of each CA authority stored in the keystore 200. If an expired CA authority is identified, CA authority expiration module 134 generates an alert that notifies an operator that the identified CA authority has expired. This alert may comprise, for example, an e-mail alert. In some embodiments, the CA authority expiration module 134 may also generate an alert any time a CA authority in the keystore 200 has an approaching expiration date (e.g., will expire within a month). By identifying CA authorities that are set to soon expire in advance and generating an alert at that time, it may be possible to significantly reduce the likelihood that an expired CA authority will cause an error condition.

The digital certificate verification module 136 is used to verify that the keystore 200 includes each required digital certificate. As discussed above, typically a variety of different digital certificates 202, 204, 206, 208 will be stored in the keystore 200. These digital certificates 202, 204, 206, 208 typically (although not always) expire a year after they are issued, and hence must be periodically replaced. As with the CA authorities, typically the replacement process is a manual (i.e., not automatic) operation. Typically, the Certificate Authority that issued the digital certificate will send a notice to an entity a few months in advance of the expiration date listed in expiration date field 28 of the digital certificate (see FIG. 2). However, the individual at the entity that is responsible for replacing expired digital certificates may have left the entity, may not actually receive the notice, may forget to replace the digital certificate before it expires, may replace the digital certificate with the wrong digital certificate, may store the replacement digital certificate in the wrong location or make any of a variety of other errors that result in the keystore 200 not having an unexpired version of each required digital certificate. Client computers attempting to establish a secure communications link to the server 220 that receive an expired digital certificate will generate an error message indicating to the user of the client computer that the client computer was unable to authenticate the server 220 and/or establish a secure connection. To prevent this error condition from occurring, digital certificate verification module 136 is used to periodically (e.g., once a week) compare the digital certificates stored in keystore 200 to a predetermined list of required digital certificates that are listed in digital certificate verification module 136. If any of the required digital certificates are missing, digital certificate verification module 136 generates an alert that notifies an operator (e.g., by e-mail) that a required digital certificate is missing.

The digital certificate expiration module 138 periodically checks to make sure that none of the digital certificates have expired. The digital certificate expiration module 138 may accomplish this, for example, by scanning the expiration date field 28 of each digital certificate stored in the keystore 200 (see FIG. 2). If an expired digital certificate is identified, digital certificate expiration module 138 generates an alert that notifies an operator that the identified digital certificate has expired. In some embodiments, the digital certificate expiration module 138 may also generate an alert any time a digital certificate 202, 204, 206, 208 in the keystore 200 has an approaching expiration date (e.g., will expire within a month). By identifying digital certificates that are set to soon expire in advance and generating an alert at that time, it may be possible to significantly reduce the likelihood that an expired digital certificate will cause an error condition.

The digital certificate validation module 140 periodically checks to make sure that each of the digital certificates stored in keystore 200 are valid, operable certificates. Digital certificate validation module 140 may accomplish this by, for example, periodically “chaining” each digital certificate stored in the keystore 200. Typically, a digital certificate will have a tiered structure so that two or more CA authorities are required to decrypt and read the certificate. The digital certificate validation module 140 in essence pulls each digital certificate 202, 204, 206, 208 in turn from the keystore 200 and performs this validation process on the each certificate 202, 204, 206, 208 using, for example, the CA authorities stored in keystore 200 to confirm that the digital certificate 202, 204, 206, 208 will operate properly and allow for the creation of a secure link. This process is useful because digital certificates may sometimes be issued by a Certificate Authority that are inoperable (or which do not operate properly). By using the digital certificate validation module 140 to periodically confirm that the digital certificates stored in keystore 200 operate properly, instances where a malformed or otherwise inoperable digital certificate prohibit a client from being able to authenticate server 220 and/or establish a secure connection to server 220 may be reduced or minimized. If an inoperable digital certificate is identified, digital certificate validation module 140 generates an alert that notifies an operator (e.g., by e-mail) that the identified digital certificate is not working properly.

The CMS password verifier module 142 periodically checks to make sure that a CMS password on the keystore (if any) has not expired. Many keystores are coded using an application known as Java-based content management system or “CMS.” CMS has a password feature, and this password can be set to expire. If keystore 200 is implemented in CMS and the password is allowed to expire, then the keystore 200 may no longer be accessible. If the CMS password verifier module 142 determines that keystore 200 is implemented in CMS, it periodically checks to make sure that any password has not expired and/or is not about to expire. If it is determined that a CMS password has, or is about to, expire, CMS password verifier module 142 generates an alert that notifies an operator (e.g., by e-mail) that the CMS password has or is about to expire, as appropriate.

As is further shown in FIG. 3, the encryption validation system 100 may also include a scheduler 150. In some embodiments, the scheduler 150 may be used to determine when each of the modules 132, 134, 136, 138, 140, 142 perform their verification/validation operations. Scheduler 150 may be implemented as a custom software program. In other embodiments, a scheduler such as a system scheduler running on, for example, server 220 may be used.

In FIG. 3, encryption validation system 100 is shown as being a separate system from server 220, and the memory associated with the server 220. It will be appreciated, however, that in some embodiments processor 120 may comprise a processor of server 220, and memory 130 may comprise, for example, the memory 230 associated with server 220.

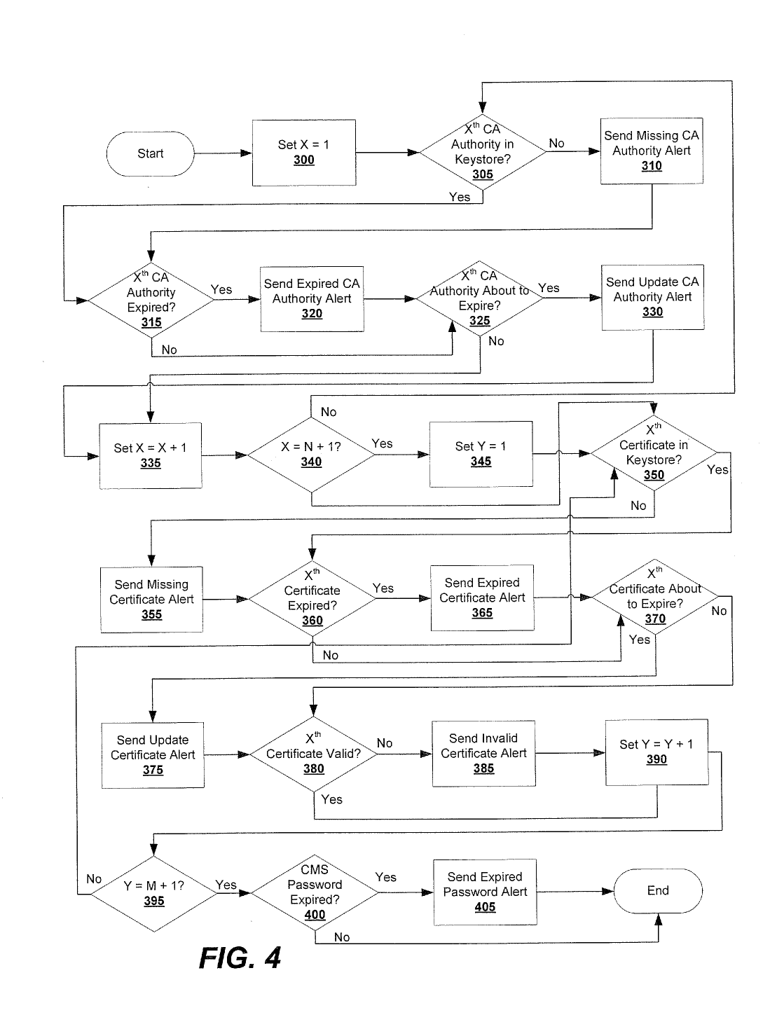

FIG. 4 is a flowchart of operations that may be performed to confirm that all required digital certificates and CA authorities are present within a particular keystore, to verify that these digital certificates and CA authorities are unexpired and to otherwise validate that the keystore should operate properly, and issue appropriate alerts if problems or potential problems are identified. In the flowchart of FIG. 4, there are N required CA authorities that should be stored in the keystore and M required digital certificates that should be stored in the keystore.

As shown in FIG. 4, operations may begin at block 300 by setting a counter X to have a value of 1. Then the keystore is checked to determine if the first of the N required CA authorities is stored in the keystore (block 305). If the first of the required CA authorities is not in the keystore, then an alert is issued (block 310), and operations proceed to block 315. If, on the other hand, the first of the required CA authorities is in the keystore, then operations proceed directly to block 315 without an alert. At block 315, a determination is made as to whether the first of the N required CA authorities has expired. If the expiration date on the first of the required CA authorities has passed, then an alert is issued (block 320), and operations proceed to block 325. If the first of the required CA authorities has not expired, then operations proceed directly to block 325 without an alert. At block 325, a determination is made as to whether the first required CA authority is set to expire within a predetermined time (e.g., within one month). If it is, then an alert is issued (block 330), and operations proceed to block 335. If the first of the required CA authorities is not set to expire within the predetermined time, then operations proceed directly to block 335 without an alert. At block 335, the counter X is incremented by one. Operations then proceed to block 340, where a determination is made as to whether the current value of X is equal to N+1. If it is not, then operations proceed to block 305, and the operations of blocks 305 to 340 are then repeated until the system has checked to determine if all of the required CA authorities are in the keystore, and to check whether or not those required CA authorities have expired and/or are about to expire. It will be appreciated that the operations of blocks 325 and 330 would typically be omitted as unnecessary—even in embodiments that check for upcoming expiration dates—if it is decided at block 315 that a particular CA authority has expired.

If, at decision block 340, it is determined that X is equal to N+1, then a second counter Y is set to the value 1 (block 345). Then the keystore is checked to determine if the first of the M required digital certificates is stored in the keystore (block 350). If the first of the required digital certificates is not in the keystore, then an alert is issued (block 355), and operations proceed to block 360. If, on the other hand, the first of the required digital certificates is in the keystore, then operations proceed directly to block 360 without an alert. At block 360, a determination is made as to whether the first of the M required digital certificates has expired. If the expiration date on the first of the required digital certificates has passed, then an alert is issued (block 365), and operations proceed to block 370. If the first of the required digital certificates has not expired, then operations proceed directly to block 370 without an alert. At block 370, a determination is made as to whether the first required digital certificate is set to expire within a predetermined time (e.g., within one month). If it is, then an alert is issued (block 375), and operations proceed to block 380. If the first of the required digital certificates is not set to expire within the predetermined time, then operations proceed directly to block 380 without an alert. It will be appreciated that the operations of blocks 370 and 375 would typically be omitted as unnecessary—even in embodiments that check for upcoming expiration dates—if it is decided at block 350 that a particular digital certificate has expired.

At block 380, a determinations made as to whether or not the first of the required digital certificates operates properly. As discussed above, this may be accomplished by using the CA authorities that are associated with the digital certificate to “chain the certificate” and thus make sure that the certificate can be decrypted and read. If it is determined at block 380 that the first of the required digital certificates does not operate properly, then an alert is issued (block 385), and operations proceed to block 390. If the first of the required digital certificates is found to operate properly, then operations proceed directly to block 390 without an alert. At block 390, the counter Y is incremented by one. Operations then proceed to block 395, where a determination is made as to whether the current value of Y is equal to M+1. If it is not, then operations proceed to block 350, and the operations of blocks 350 to 395 are then repeated until the system has checked to determine if all of the required digital certificates are in the keystore and operate properly, and to check whether or not those required digital certificates have expired and/or are about to expire.

If, at decision block 395, it is determined that Y is equal to M+1, then a determination is made as to whether or not any CMS password that is set on the keystore has expired (block 400). If it has, then an alert is issued (block 405), and then operations may conclude. If there is no password or it has not expired, then operations also conclude.

It will be appreciated that the operations of FIG. 4 may be carried out periodically. Herein, the term “periodically” is used to indicate that a step or operation is performed from time-to-time. The term “periodically” thus is not intended to imply or require that the step or operation be performed at fixed intervals. It will likewise be appreciated that, according to some embodiments, the periodic operations of FIG. 4 may be carried out independent of receipt of an error message or some other indication that the keystore or the contents thereof are not working properly. Thus, for example, the operations of some or all of blocks 305, 315, 325, 350, 360, 370, 380 and 400 of FIG. 4 may be performed periodically as part of routine maintenance operations as opposed to being specifically performed because an error message has been received or a problem has been identified. Morover, pursuant to yet additional embodiments, a frequency at which the operations of the various methods disclosed herein may be increased in response to receipt of an error message.

It will also be appreciated that while FIG. 4 discloses one particular method, that in other embodiments, various of the operations of FIG. 4 may be omitted. For example, in certain embodiments, only operations 300, 305, 310, 335 and 340 would be performed, and the connectors on FIG. 4 would be modified appropriately. In other embodiments, only operations 300, 305, 310, 315, 320, 335 and 340 would be performed, and the connectors on FIG. 4 would be modified appropriately. In still other embodiments, only operations 300, 305, 310, 325, 330, 335 and 340 would be performed, and the connectors on FIG. 4 would be modified appropriately. Numerous other combinations are readily apparent and hence will not be described further here. It will also be appreciated that a system or computer program product that carries out some or all of the operations of FIG. 4 may also carry out additional operations relating to, for example, ensuring that a keystore operates properly.

It will be appreciated that while in the flow chart of FIG. 4 the operations for checking to determine if a required CA authority (or a required digital certificate) has expired and the operations for checking to determine if a required CA authority (or a required digital certificate) is set to expire within a predetermine time are shown as comprising separate operations, these operations may be performed together in a single step in some embodiments.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed various embodiments and, although specific terms are employed, they are used in a generic and descriptive sense only and not for purposes of limitation.

What is claimed is:

1. A method of verifying the operability of an encryption keystore, the method comprising:
periodically checking the keystore to verify that the keystore includes each required CA authority; and
automatically issuing an alert if one or more of the required CA authorities are missing from the keystore.

2. The method of claim 1, further comprising periodically checking the keystore to determine if any of the required CA authorities have expired; and
automatically issuing an alert if one or more of the required CA authorities have expired.

3. The method of claim 1, further comprising periodically checking the keystore to determine if any of the required CA authorities are set to expire within a predetermined time period; and
automatically issuing an alert if one or more of the required CA authorities are set to expire within the predetermined time period.

4. The method of claim 1, further comprising periodically checking the keystore to verify that the keystore includes each required digital certificate; and
automatically issuing an alert if one or more of the required digital certificates are missing from the keystore.

5. The method of claim 4, further comprising periodically testing a first of the required digital certificates to determine if the first of the required digital certificates operates properly; and
automatically issuing an alert if the first of the required digital certificates is determined to not be operating properly.

6. The method of claim 5, wherein testing the first of the required digital certificates to determine if the first of the required digital certificates operates properly comprises:
obtaining a copy of the first of the required digital certificates from the keystore; and
using at least one CA authority to decrypt the first of the required digital certificates.

7. The method of claim 4, further comprising periodically checking the keystore to determine if any of the required digital certificates have expired; and
automatically issuing an alert if one or more of the required digital certificates have expired.

8. The method of claim 4, further comprising periodically checking the keystore to determine if any of the required digital certificates are set to expire within a predetermined time period; and
automatically issuing an alert if one or more of the required digital certificates are set to expire within the predetermined time period.

9. The method of claim 4, wherein the keystore comprises a CMS keystore, the method further comprising periodically checking the CMS keystore to determine if a password for the CMS keystore has expired; and
automatically issuing an alert if the password for the CMS keystore has expired.

10. An encryption validation system for a keystore that contains a plurality of digital certificates and a plurality of CA authorities, comprising:
a verifier that is configured to periodically check the keystore to determine if the keystore has each of a specified set of CA authorities and each of a specified set of digital certificates.

11. The encryption validation system of claim 10, wherein the verifier is further configured to periodically check the keystore to determine if any of the plurality of digital certificates are expired.

12. The encryption validation system of claim 11, wherein the verifier is further configured to periodically check the keystore to determine if any of the plurality of digital certificates are set to expire within a predetermined time.

13. The encryption validation system of claim 12, wherein the verifier is further configured to periodically check the plurality of digital certificates to determine if each of the digital certificates operates properly.

14. The encryption validation system of claim 10, wherein the verifier is further configured to periodically check the keystore to determine if any of the plurality of CA authorities are expired.

15. The encryption validation system of claim 14, wherein the verifier is further configured to periodically check the keystore to determine if any of the plurality of CA authorities are set to expire within a predetermined time.

16. The encryption validation system of claim 11, wherein the keystore comprises a CMS keystore, and wherein the verifier is further configured to periodically check if a password for the CMS keystore has expired.

17. A computer program product for verifying the operability of an encryption keystore, the computer readable program product comprising a computer readable medium having computer readable program code embodied therein, the computer readable program code comprising:
computer readable program code that is configured to check the keystore to verify that the keystore includes each required CA authority;
computer readable program code that is configured to check the keystore to determine if any of the required CA authorities have expired;
computer readable program code that is configured to check the keystore to verify that the keystore includes each required digital certificate; and
computer readable program code that is configured to check the keystore to determine if any of the required digital certificates have expired.

18. The computer program product of claim 17, further comprising computer readable program code that is configured to check the keystore to determine if any of the required CA authorities are set to expire within a predetermined time period and computer readable program code that is configured to check the keystore to determine if any of the required digital certificates are set to expire within a predetermined time period.

19. The computer program product of claim 18, further comprising computer readable program code that is configured to automatically issue an alert if one or more required CA authorities or digital certificates are missing from the keystore, or if any of the required CA authorities or digital certificates are set to expire within the predetermined time period.

20. The computer program product of claim 18, further comprising computer readable program code that is configured to test the required digital certificates to determine if each of the required digital certificates operates properly.
